(19) United States
(12) Patent Application Publication
(10) Pub. No.: US 2020/0050679 A1
(43) Pub. Date: Feb. 13, 2020

(54) System, Method and computer program product for determining Thermodynamic Properties or scientific properties and communicating with other systems or apparatus for Measuring, Monitoring and Controlling of Parameters

(71) Applicant: Arya Deepak Keni, Woodbridge, NJ (US)

(72) Inventor: Arya Deepak Keni, Woodbridge, NJ (US)

(73) Assignee: Arya Deepak Keni, Woodbridge, NJ (US)

(21) Appl. No.: 16/101,405

(22) Filed: Aug. 11, 2018

(51) Int. Cl. G06F 17/30

(52) U.S. Cl. CPC G06F 17/3056; G06F 3/04842; G06F 17/30525; G06F 17/30554

(57) ABSTRACT

This patent discloses methods, systems and computer program product for locally or remotely requesting thermodynamic and scientific properties determination from a mobile device or non mobile device such as a smart phone or tablet; or non mobile device such as a computer and communicating over a data network, with other thermodynamic or scientific systems or apparatus for measuring, monitoring and controlling of parameters. The methods and systems use primary and secondary sources of data in real time to calculate and communicate the thermodynamic or scientific properties to end-user or other systems or apparatus for measuring, displaying, monitoring and controlling of parameters based on threshold limits and set parameters.

### RELATED APPLICATIONS

None

### BACKGROUND & FIELD OF THE INVENTION

### Field of the Invention

The System, Method and computer program product serves to simplify research and processes in material science and cryogenics and relevant process industries by a provision of a multi-tool (as discussed in claims) material property (such as Thermal Conductivity, Specific Heat capacity, Young's modulus, Linear Expansion, and Expansion Coefficient and other such properties) and temperature calculator, for quick calculations and analysis of cryogenic materials and thermodynamic or scientific materials and relevant processes (used for designing products or manufacturing, or any other wide use). A prospective link and method of communication via a data network of this computer program product to thermodynamic or scientific apparatus or cryogenic hardware would provide an effective source for local or remote monitoring and control of previously manually controlled devices and processes.

### BACKGROUND OF THE INVENTION

Many researchers, scientists and industries, particularly in the field of cryogenics or material sciences, lack an automated method of calculation and database for material property and temperature calculation, as well as other processes to analyze and process the materials for further use. NIST (National Institute of Standards and Technology) provides only a reference to the materials and properties, thus leaving researchers, scientists and industries, with tedious manual calculations to arrive at only one output of the computation.

Further complex mathematical processes on the functions to be done manually to obtain more data points is almost impossible at a manual pace. With the growing age of reliance on technology and sophisticated (and automated) algorithms to simplify redundant and excessive procedures, this invention promises exactly the proposed statement, in a way that will be discussed in detail in the following sections. These obstacles will be tackled by the proposed system (of software), to provide for a much smoother and insightful research process related in any way to the database of materials or thermodynamics.

Thermodynamic or scientific apparatus or cryogenic hardware, previously manually calibrated and monitored, can also be done effectively via this computer program product integration to said hardware over a data network.

### SUMMARY

### BRIEF SUMMARY OF THE INVENTION

The present invention incorporates a number of known technologies into a novel system for making thermodynamic or scientific or cryogenic determinations. More particularly, embodiments of the present invention use a mobile application client (an “App”) and ability for the mobile application client or non mobile application client to perform search or calculations and communicate with other thermodynamic or scientific or cryogenic hardware or apparatus over a data communications network. The proposed method, system or computer program product (a web-computational tool (accessible with/out internet connection)) will solve all of the above stated problems by automating all possible ‘useful’ scientific outputs by means of mathematical manipulation of functions and complex computations of numerous data inputs instantaneously (from the new functions, or the original) (chosen by the user or another apparatus or device or system: dependent on type of calculation or data retrieval to be performed).

The invention's computer program product consists of software with 5 components which can be further extended for providing more related functions and features:

1. A multiple option matrix of ‘property calculator’ which displays the required output of the material and its property value (accurately upto the maximum number of decimal places possible), based on a singular degree Kelvin scale temperature input and the choice of material and property from a search field or drop down column (holding the list of all matrix position possibilities (combinations of property and material))

2. The inverse function matrix of the first component which outputs the degree Kelvin scale temperature based on the material property value input, after choosing from the material and property from a search field or drop down column (holding the list of all matrix position possibilities (combinations of property and material))

3. The graphing functionality, which outputs an interactive and comprehensive graph based on the choice of the material and property from a search field or drop down column (holding the list of all matrix position possibilities (combinations of property and material)) as well as the degree Kelvin temperature domain constraints, essentially modelling the property function assigned to that matrix position. It also computes and outputs the bounded integral of the graphed function between the input temperature domain, using the ‘step length’ as a part of the computing process to accurately compute the integral

4. The comparing algorithm, which effectively utilizes the functions stated in the first component, but involves additional list of matrices (of a combination of properties and materials), and choosing these results in the output of a tabular format, including the material, property and the temperature in the tab. Such a format provides for easy comparison between the computed outputs, effectively minimizing processes to arrive at decisions regarding these properties and values as discussed in the background of the application.

5. The additional features package, which comprises of finer details regarding experimental accuracy and display of the algorithm design, consisting of significant figure checks, uncertainty checks and easy to comprehend web-pattern (with a simple layout and display format), along with post-processing-downloadable data files. The computer program product will also contain additional scientific tools and user guidance methods and systems which will be discussed in detail later (in the detailed description section).

These components are effectively accessible by the bundling algorithm, causing multiple such facets of specific code-language classes accessible under one domain. With button and click functionalities, recording inputs and switching between components is made extremely simple.

This bundle-functionality domain is accessible with and without internet application, in the form a web-computational tool online and in the form of a scientific application (downloadable) offline and send or receive data over a data network to other users, systems or hardware or apparatus

The method of data-processing in the bundle-functionality will be described in detail in the later sections. The method generally entails the way in which the computer program product will ‘flow’ the data through the program, giving the desired output.

These functionalities provided through the systems or computer program product can be easily linked via a data communication network to any relevant local or remote thermodynamic or scientific or cryogenic hardware (Dewar vessels for instance) to augment their factors, which will be discussed in detail in the following sections.

### BRIEF DESCRIPTION OF DRAWINGS

FIG. 1.: Data structure of user input processing by computer program product for component 1 under the domain, providing a comprehensive understanding of the path of input data through computer program product sub-classes, providing an output

FIG. 2.: Data Structure of user input processing by computer program product by component 2 under the domain, providing a visual representation of the flow of data through the computer program product functionalities, thus providing an output on the real domain of numbers

FIG. 3.: A drawing representing the input data interaction between the pre-set functions, the mathematical data-process functions (mainly regarding integration) and the visualization kit invocation of the google chart library APIs

FIG. 4.: The multi-link (between the matrix possibilities and the input data) representation of the input flow between the processing functions (utilizing combinatorial properties to decide possible comparisons) to generate an output

FIG. 5.: A depiction of the wireless connection and transmission of data from and to relevant local or remote thermodynamic or scientific or cryogenic hardware (Dewar vessels for instance) and the computer program product algorithm on the mobile device or non mobile device (having computational capabilities)

### SPECIFICATIONS—DETAILED DESCRIPTION

This invention, as discussed previously, comprises of computer program product systems to rely on useful output to the ‘research community’ and scientists or industries. These computer program product and systems and method will be discussed in detail using the drawings, as they represent all the aspects of the computational-tool. The user can directly interact with the computer program product to provide inputs and receive outputs. The apparatus or device or other systems can interact with the computer program product via an application program interface (API) which allows two way information communication between the computer program product and the apparatus or device or other systems.

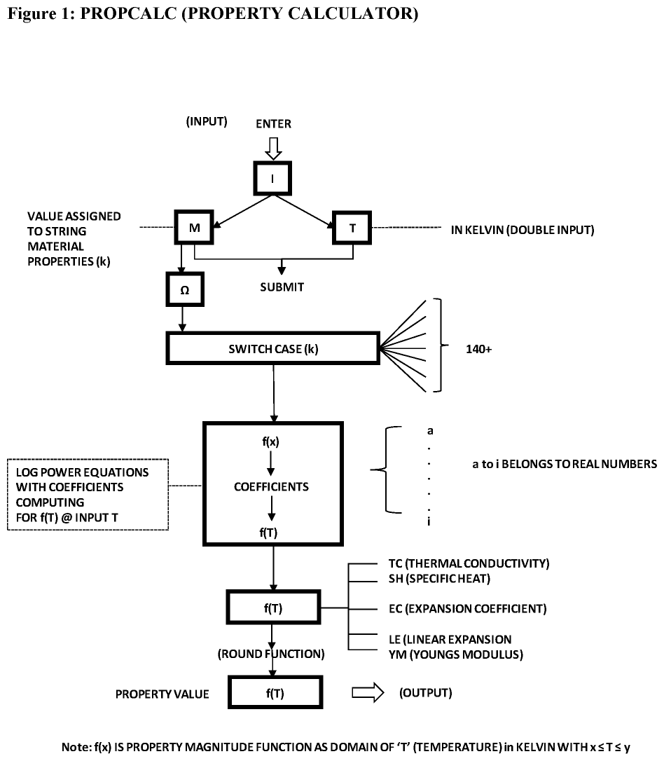

Referencing FIG. 1.: The user or another apparatus or device or system would choose the ‘Properties Calculator’ by clicking/tapping onto the reference button visual, and choosing the material and property (matrix transformed to a singular list between all linear combinations),

whose unique numerical identifiers are used in the switch-case scenario of all the possibilities. The temperature in degree Kelvin serves as a solving parameter of the logarithmic equation situated in each switch-case scenario (with unique coefficients pertaining to each material and property possible). The numerical parameter is used in the equation to generate the numerical property value and assign it to a common variable accessible by all cases. The variable is then displayed in the designated reference tag.

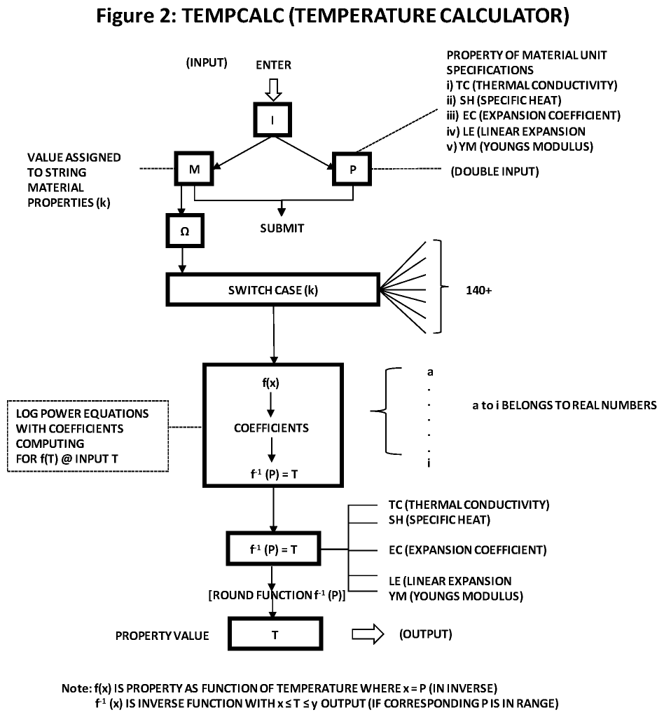

Referencing FIG. 2.: The user or another apparatus or device or system would choose the ‘Temperature Calculator’ by clicking/tapping onto the reference button visual, and choosing the material and property (matrix transformed to a singular list between all linear combinations), whose unique numerical identifiers are used in the switch-case scenario of all the possibilities. The numerical value of the property will be the solving parameter, where each switch-case scenario will contain unique coefficients and logarithmic functions pertaining to the property value and material. A prospective N-case for loop will be run through the initialized function, with infinitesimal increments in the temperature (in Degree Kelvin) across the specified domain (in the drop down next to each material and property combination). The generated answer with each temperature possibility within the domain is checked for numerical equality with the solving parameter (with an absolute difference leeway of a negligible quantity (about 0.001 K)) The loop is broken after the conditions are met and the index position of the loop is recorded beforehand in a global accessible variable. The consequent temperature value in Degree Kelvin is then displayed in the designated reference tag.

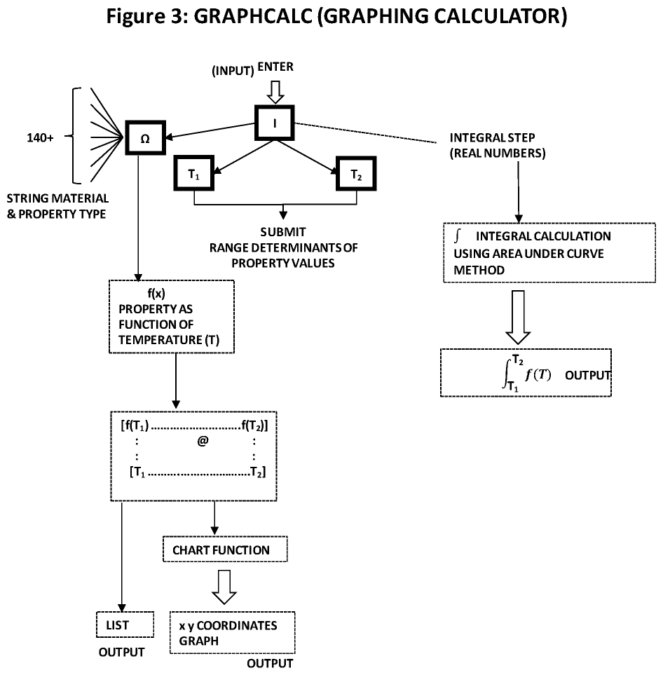

Referencing FIG. 3.: The user or another apparatus or device or system would choose the ‘Graphing Calculator by clicking/tapping onto the reference button visual, and choosing the material and property (matrix transformed to a singular list between all linear combinations), whose unique numerical identifiers are used in the switch-case scenario of all the possibilities. There will be 3 more inputs, namely to set the real domain of the pushed visual function (charted graph), and a decimal input to determine the step length of the calculated integral, also utilized to calculate the bounded integral. The unique numerical identifier is utilized to ‘enter’ into a switch-case scenario, and an argument for loop is utilized at an increment of the step length to generate a new temperature index (as an x coordinate), and the corresponding material and property function which utilizes each such increment to output the numerical property value as a y coordinate, are both stores in separate arrays with each corresponding x and y coordinate having the same index position. For a particular input query (input instance), these 2 null arrays are updated with the generated values (the arrays having a pre-calculated length using the step-length input to occupy all the generated values). These values are pushed in the form of the arrays of coordinates making points on the cartesian plane, using the google charts library to draw a function into the customizable grid (consisting of the axes, labels and the grid lines) and calling the chart function into the usual output function displays the developed chart to the user. The integral is calculated and is displayed in the designated reference tag, mainly by using Euler' s step length method of rectangular approximation of areas under a curve (with a step length closer to 0 giving a more accurate output).

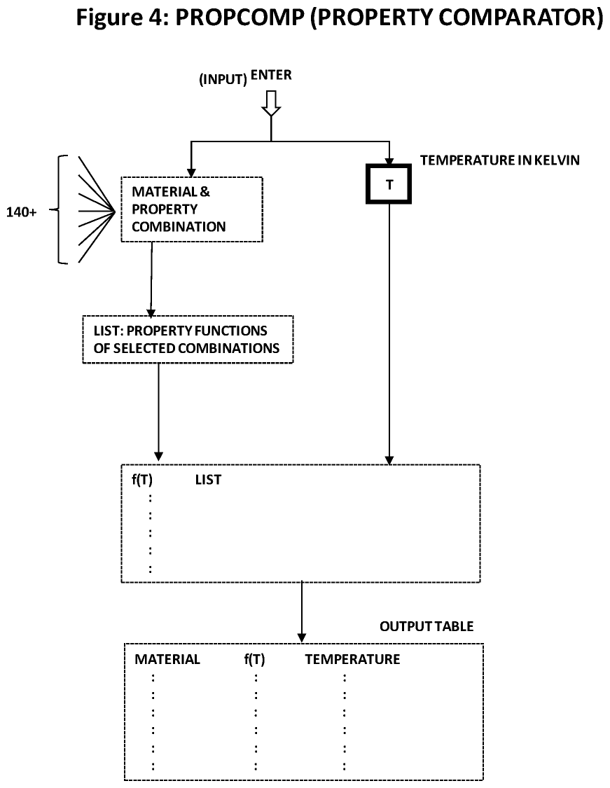

Referencing FIG. 4.: The user or another apparatus or device or system would choose the ‘Properties Comparator’ by clicking/tapping onto the reference button visual, and choosing the material and property (matrix transformed to a singular list between all linear combinations), whose unique numerical identifiers are used in the switch-case scenario of all the possibilities. Additional possibilities of drop down identifiers are generated by the ‘delta function described in ‘Referencing FIG. 6. Subpart ‘B’’, and are made available for user interaction. A choice of one of these drop down linearities, and the solving parameter of the input temperature is required for the algorithm to find a unique tag identifier for each corresponding possibility. For non-linear comparisons, switch-case tags associated with each linear component is identified and accessed for calculations. The calculation pattern follows as described in ‘Referencing FIG. 1’, but in this data flow instance, multiple such calculation patterns for each linear combination (constituents of the non-linear matrix of additional possibilities) occur, all stored sequentially in a ‘double’ category array, with a corresponding linear combination ‘string’ tag in another array (with same index references). The data is pushed by a single access for loop in a tabulated fashion comprising of the input temperature, and these to array indices till full length. This pushed table is accessed and displayed by a reserved tag area below the input.

All components (FIGS. 1-4) have an encoded text to notify the user or another apparatus or device or system about units and measurement standards of the materials and properties, for quick reference.

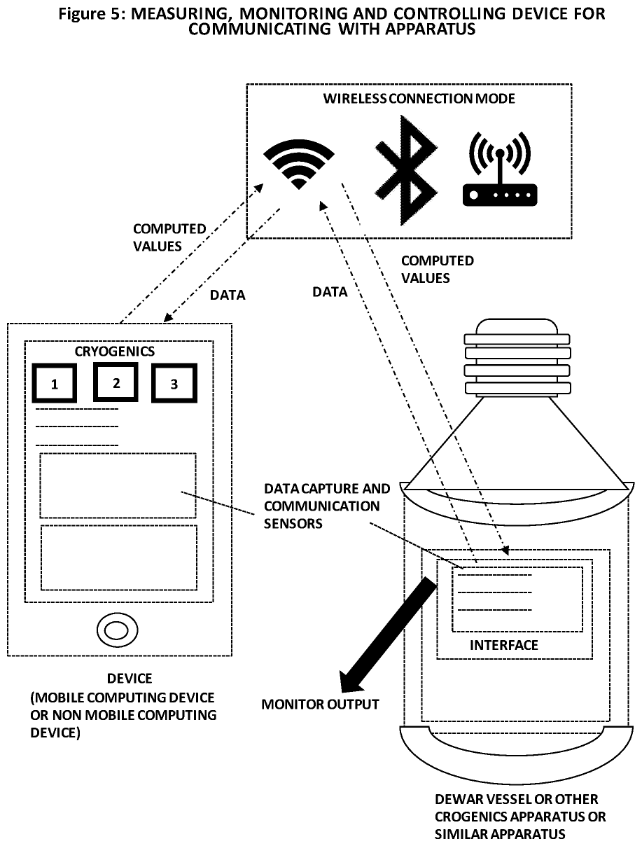

The bundling of all the components is done in the most simple way by enabling the following interface: a home page with component 1 as the default setting and 4 possible access buttons for each component (1-4) which refreshes the interface and displays the default condition of each component (1-4). Using each component alternatively as described above and receiving and output is observed without a screen refresh. After obtaining a suitable output, any other button functionality would lead the user to the same process described above in this ‘Referencing FIG. 5’ itself. Manually using the reset button would set the screen calculator (chosen) to its default condition, and resetting/refreshing the browser would redirect the user to the home page.

Subpart ‘A’ depicts the ‘omega’ (or Ω) functionality, used to form a linear combination of property and material out of 2 one dimensional string arrays for properties and materials, and assigning each combination in the 2 dimensional matrix a unique identifier to be used in the switch case scenario. Subpart 13′ depicts the ‘delta’ (or δ) functionality, used in component 4, mainly to form ‘links’ between separate material and property arrays to form a matrix with links of more than just 1 property and 1 value, for a more vast search option provision.

The computer program product is capable to deal with decimal numbers, except in the unique identifiers of the material and property combinations which have to be whole numbers

Referencing FIG. 5.: The figure depicts a wireless link between the mobile device or non mobile device and the Dewar vessel (or other scientific or thermodynamic or cryogenic apparatus or system) where the Dewar vessel transmits collected values to the computer program product via the interface attached, and the computer program product relays the computed relevant values back to the monitor for display and regulation. The sensor in the vessel reads and measures data related to thermodynamic processes (pertaining to the vessel) for transmission. This way, even multiple apparatus can be connected to the same device or similar cryogenic devices and monitored simultaneously by this data-relaying process (including a transmitter and receiver with a wireless connection)

Regarding the additional features, they all comprise of computer program product enhancements to all the calculators for scientific accuracy regarding experimental data and to promote quick and efficient use by user-friendly and comprehensible instruction design.

The Additional Features and their Corresponding Explanation are as Follows:

Uncertainty Accounting: The output in all the calculators, will also calculate the property values with the uncertainty (percentage of the magnitude of the property added and subtracted, and will output them accordingly (tabular for multiple values, or as is for singular values). The graphical output will also entail the graph of the values with the subtracted and added percentage uncertainty (3 graphs in total, with ideal, added and subtracted uncertainties). The user will be asked for the number of significant digits I output desires, but will be notified about the ideal numbers depending on the context of use and accuracy required.

User-Neutral Interface and ability: The color and arrangement style of the text, instructions, headings, and pictures will be in a style and format that isn't strenuous or non-appealing to certain communities (like the usage of blue in “Facebook” website to not affect red-green colorblind people and their usage of the interface).

Warning Gestures: Scientific experimentation and yielded data or assets (such as non calculated or calculated values or data or metadata or digitized content) must be used specifically in certain fashions, also with precision. Guidelines on these implications and its importance will be set up in a clear manner on the user visuals panel. Any tampering (in terms of inputting data which may be incorrect or inapplicable in certain cases (like inputting outside the specified domain) will be notified about to the user (specific to each case chosen).

Downloadable Data Sets or assets: The data or assets (such as non calculated or calculated values or data or metadata or digitized content) produced will be automatically downloaded in the ‘downloads’ folder of the device, as an excel file for further future reference or analysis. Alternatively, a manual method for doing the same will also be displayed if the user prefers so.

Comprehensibility Boost in output: The output will be boldened, separated from the other text, and tabulated neatly (if required), to allow quick and simple reference of the output directly on the screen by the user.

This application provides an innovative and automated approach to complex and precise computations with record speed, by effectively taking a manually processable database (on the NIST webpage) and rendering it into a computational methods and systems, understandable by any device or platform with a processing unit.

Thus, this bundled computer program product offers a sophisticated and precise method of functioning, ultimately benefitting the users with huge amounts of processed data from limited inputs, previously almost impossible to do so due to the requirement of a very high level of complex mathematical capabilities and a large amount of time.

Thus this computer program product (or web-computational tool and application) offers accuracy and efficiency (in time and vastness of data processed) regarding scientific data related to materials.

For all components requiring scientific data for the data flow process, it has been referenced from the NIST materials science page to be utilized.

Regarding the hardware application, this computer program product can be further enhanced for a multi-device link to monitor, providing effective additional uses of the computer program product to further benefit the cryogenic research and development as a whole.

While specific ideas and embodiments have been illustrated and described, numerous modifications come to mind without significantly departing from the spirit of the invention, and the scope of protection is only limited by the scope of the accompanying claims.

### Abbreviations in Drawings Explained:

1. YM: Youngs Modulus

2. TC: Thermal Conductivity

3. SH: Specific Heat

4. EC: Expansion Coefficient

5. f(x): Function of the specific material and property

6. R: Real Numbers

7. x: input value/lower limit

8. y: input value/upper limit

9. T: Temperature

10. P: Property (also written as f(T))

11. M: Material

12. f−1(x): Inverse function (also written as f−1(P)=T)

13. ∫ f (x) : Integral calculation of the function (property value from the upper and lower temperature limits

What is claimed is:

1. An system for cryogenic or scientific use, comprising various processing algorithms to handle and communicate immense scientific data,
mainly comprising of hardware processing circuitry and mobile or non mobile device or non mobile devices and/or another apparatus or device and mobile or non mobile device thermodynamic properties search app client:
and capable of receiving from a user or another apparatus or device or system, a request to search or calculation for thermodynamic or scientific property determinations, the request comprising a keyword or multiple keywords or selections or values; based on receiving the request: retrieving, from storage circuitry,
thermodynamic or scientific property determinations search or calculation or calculator engine comprising of;
a data apparatus or device comprising a plurality of database entries each corresponding to a respective thermodynamic or scientific property asset (such as non calculated or calculated values or data or metadata or digitized content),
wherein each database entry comprises descriptive metadata associated with the respective thermodynamic or scientific property asset (such as non calculated or calculated values or data or metadata or digitized content);
comparing, using control circuitry, the keyword or multiple keywords or selections or values to the descriptive metadata associated with each of the plurality of database entries; identifying, based on the comparing, a subset of the plurality of database entries that are associated with the descriptive metadata that includes the keyword or multiple keywords or selections or values,
an application program interface to allow two way communication, interaction and data sharing between the computer program product and other relevant apparatus or devices or systems,
wherein the subset of the database entries comprises database entries for thermodynamic or scientific property determinations; and storing, in user or another apparatus or device or system interaction metadata, the request;
receiving, from the user or another apparatus or device or system, a selection of the thermodynamic or scientific property asset (such as non calculated or calculated values or data or metadata or digitized content); based on receiving the selection of the thermodynamic or scientific property asset (such as non calculated or calculated values or data or metadata or digitized content) storing, in user or another apparatus or device or system interaction metadata associated with the request, an indication of the selection of the thermodynamic or scientific property asset; receiving, from the user or another apparatus or device or system; generating a list of thermodynamic or scientific property determinations including the thermodynamic or scientific property asset (such as non calculated or calculated values or data or metadata or digitized content) and
where in the thermodynamic properties search app client comprises:
software to interact with and present data to a user via the user interface,
software to interact with and present data to another apparatus or device or system interface,
software to retrieve data comprising at least one sensor reading from the another sensor associated with another apparatus or device or system interface,
software to send the retrieved data from mobile or non mobile device to the thermodynamic or scientific property determinations search or calculation or calculator engine via the data network interface,
and wherein the system comprises:
wherein the at least one computer processor of at least one of: the mobile or non-mobile device or non mobile device, the thermodynamic or scientific property determinations search or calculation platform device, or the thermodynamic or scientific property determinations platform, is configured to: calculate the thermodynamic or scientific property or associated attributes;
and wherein the at least one processor is configured to send the thermodynamic or scientific property or associated attributes of the apparatus or device to the thermodynamic or scientific property determinations search or calculation or calculator engine via the data network interface, and receive thermodynamic or scientific property determinations data at the mobile device or non mobile device or non mobile device for the apparatus or device, from the thermodynamic or scientific property determinations search or calculation or calculator engine via the data network interface, and display the thermodynamic or scientific property determinations data on the user or another apparatus or device or system interface of the mobile or non-mobile device or non mobile device;
wherein the thermodynamic or scientific property determinations search or calculation or calculator engine comprises wherein the at least one computer processor of the thermodynamic or scientific property determinations search or calculation platform device is configured to receive the derived or calculated data from the thermodynamic or scientific property determinations search or calculation or calculator app client via the data network interface, send the derived or calculated data to the thermodynamic or scientific property determinations process parameters determination subsystem computer program product via the data network interface, receive the thermodynamic or scientific property determinations data from the thermodynamic or scientific property determinations process parameters determination subsystem via the data network interface, store the derived or calculated data and the thermodynamic or scientific property determinations data in the thermodynamic or scientific property determinations search or calculation database, and send the thermodynamic or scientific property determinations data to the thermodynamic or scientific property determinations search or calculation or calculator app client via the data network interface.

2. The system according to claim 1 wherein: the thermodynamic or scientific property determinations search or calculation or calculator app is configured to read data from said another sensor of said plurality of sensors; wherein the sensors connected to Dewar vessels, or sensors connected to other thermodynamic or scientific apparatus.

3. The system according to claim 1 wherein the thermodynamic or scientific property determinations search or calculation or calculator engine comprises wherein the at least one computer processor of the thermodynamic or scientific property determinations search or calculation platform device is configured to calculate the thermodynamic or scientific property determinations from the received data.

4. The system according to claim 1 wherein: the thermodynamic or scientific property determinations search or calculation or calculator app client further comprises wherein said at least one computer processor of the mobile device or non mobile device or non mobile device is configured to automatically communicate the thermodynamic or scientific property determinations data to a pre-configured electronic address.

5. The system according to claim 1 wherein: the thermodynamic or scientific property determinations search or calculation or calculator app client further comprises wherein said at least one computer processor of the mobile device or non mobile device or non mobile device is configured to allow the user or another apparatus or device or system to send the thermodynamic or scientific property determinations data to a user or another apparatus or device or system-specified electronic address to monitor, manage or control the apparatus or device.

6. The system according to claim 1 wherein: the thermodynamic or scientific property determinations search or calculation or calculator app client further comprises wherein said at least one computer processor of the mobile device or non mobile device or non mobile device is configured to display on the user or another apparatus or device or system interface information regarding the thermodynamic or scientific property determinations data.

7. A thermodynamic or scientific property determinations client application computer program product embodied on a computer accessible medium configured to execute, on at least one computer processor of a mobile or non mobile device or non mobile device in communication or non communication with a thermodynamic or scientific property determinations search or calculation platform over a communications network, remotely obtaining thermodynamic or scientific property determinations data, comprising:
receiving, by the at least one computer processor, an interaction from a user or another apparatus or device or system by communicating over data network;
calculating, by the at least one computer processor, thermodynamic or scientific property determinations or value;
incorporating an application program interface to allow two way communication, interaction and data sharing between the computer program product and other relevant apparatus or devices or systems,
wherein the at least one computer processor of the thermodynamic or scientific property determinations search or calculation platform device is configured to receive the derived or calculated data from the thermodynamic or scientific property determinations search or calculation or calculator app client via the data network interface, send the derived or calculated data to the thermodynamic or scientific property determinations process parameters determination subsystem computer program product via the data network interface, receive the thermodynamic or scientific property determinations data from the thermodynamic or scientific property determinations process parameters determination subsystem via the data network interface, store the derived or calculated data and the thermodynamic or scientific property determinations data in the thermodynamic or scientific property determinations search or calculation database, and send the thermodynamic or scientific property determinations data to the thermodynamic or scientific property determinations search or calculation or calculator app client via the data network interface;
responding, by the at least one computer processor, to the user or another apparatus or device or system interaction by reading sensor readings from another sensor of said plurality of sensors; wherein the sensors connected to Dewar vessels, or sensors connected to other thermodynamic or scientific apparatus, and another sensor, other than a touchscreen, a keyboard, and a mouse; forming, by the at least one computer processor, a thermodynamic or scientific property determinations search or calculation request by inserting, by the at least one computer processor, the sensor readings from the plurality of sensors into the thermodynamic or scientific property determinations search or calculation request; and
sending, by the at least one computer processor, the thermodynamic or scientific property determinations search or calculation request, over the communications network, to the thermodynamic or scientific property determinations search or calculation platform;
and receiving, by the at least one computer processor, thermodynamic or scientific property determinations data, from the communications network, in response to the thermodynamic or scientific property determinations search or calculation request; and wherein the method comprises: retrieving, by the at least one computer processor, data comprising the at least one sensor reading; and calculating, by the at least one computer processor, thermodynamic or scientific property determinations or values.

8. A method, comprising various processing algorithms to handle and communicate immense scientific data,
on a mobile or non mobile device or non mobile devices and/or another apparatus or device:
capable of receiving from a user or another apparatus or device or system, a request to search or calculation for thermodynamic or scientific property determinations, the request comprising a keyword or multiple keywords or selections or values;
based on receiving the request: retrieving, from storage circuitry, communicating with a data apparatus or device comprising a plurality of database entries each corresponding to a respective thermodynamic or scientific property asset (such as non calculated or calculated values or data or metadata or digitized content) wherein each database entry comprises descriptive metadata associated with the respective thermodynamic or scientific property asset;
comparing, using control circuitry, the keyword or multiple keywords or selections or values to the descriptive metadata associated with each of the plurality of database entries;
identifying, based on the comparing, a subset of the plurality of database entries that are associated with the descriptive metadata that includes the keyword or multiple keywords or selections or values,
wherein the subset of the database entries comprises database entries for thermodynamic or scientific property determinations; and storing, in user or another apparatus or device or system interaction metadata, the request;
receiving, from the user or another apparatus or device or system, a selection of the thermodynamic or scientific property asset; based on receiving the selection of the thermodynamic or scientific property asset (such as non calculated or calculated values or data or metadata or digitized content) storing, in user or another apparatus or device or system interaction metadata associated with the request, an indication of the selection of the thermodynamic or scientific property asset;
receiving, from the user or another apparatus or device or system; generating a list of thermodynamic or scientific property determinations including the thermodynamic or scientific property asset (such as non calculated or calculated values or data or metadata or digitized content)
and wherein the system comprises: wherein the at least one computer processor of at least one of: the mobile or non-mobile device or non mobile device, the thermodynamic or scientific property determinations search or calculation platform device, or the thermodynamic or scientific property determinations platform, is configured to:
calculate the thermodynamic or scientific property or associated attributes;
and wherein the at least one processor is configured to send the thermodynamic or scientific property or associated attributes of the apparatus or device to the thermodynamic or scientific property determinations search or calculation or calculator engine via the data network interface, and receive thermodynamic or scientific property determinations data at the mobile device or non mobile device or non mobile device for the apparatus or device, from the thermodynamic or scientific property determinations search or calculation or calculator engine via the data network interface, and display the thermodynamic or scientific property determinations data on the user or another apparatus or device or system interface of the mobile or non-mobile device or non mobile device;
wherein the thermodynamic or scientific property determinations search or calculation or calculator engine comprises wherein the at least one computer processor of the thermodynamic or scientific property determinations search or calculation platform device is configured to receive the derived or calculated data from the thermodynamic or scientific property determinations search or calculation or calculator app client via the data network interface, send the derived or calculated data to the thermodynamic or scientific property determinations process parameters determination subsystem computer program product via the data network interface, receive the thermodynamic or scientific property determinations data from the thermodynamic or scientific property determinations process parameters determination subsystem via the data network interface, store the derived or calculated data and the thermodynamic or scientific property determinations data in the thermodynamic or scientific property determinations search or calculation database, and send the thermodynamic or scientific property determinations data to the thermodynamic or scientific property determinations search or calculation or calculator app client via the data network interface.

9. The method according to claim 8 wherein: the thermodynamic or scientific property determinations search or calculation or calculator app is configured to read data from said another sensor of said plurality of sensors; wherein the sensors connected to Dewar vessels, or sensors connected to other thermodynamic or scientific apparatus.

10. The method according to claim 8 wherein at least one computer processor of the thermodynamic or scientific property determinations search or calculation platform device is configured to calculate the thermodynamic or scientific property determinations from the received data.

11. The method according to claim 8 wherein: the thermodynamic or scientific property determinations search or calculation or calculator app client of the mobile device or non mobile device or non mobile device is configured to automatically communicate the thermodynamic or scientific property determinations data to a pre-configured electronic address.

12. The method according to claim 8 wherein: the thermodynamic or scientific property determinations search or calculation or calculator app client of the mobile device or non mobile device or non mobile device is configured to allow the user or another apparatus or device or system to send the thermodynamic or scientific property determinations data to a user or another apparatus or device or system-specified electronic address to monitor, manage or control the apparatus or device.

13. The method according to claim 8 wherein: the thermodynamic or scientific property determinations search or calculation or calculator app client of the mobile device or non mobile device or non mobile device is configured to display on the user or another apparatus or device or system interface information regarding the thermodynamic or scientific property determinations data.
